(19) United States
(12) Patent Application Publication
(10) Pub. No.: US 2014/0047685 A1
(43) Pub. Date: Feb. 20, 2014

(54) CASKET-LOWERING STRAP WITH DETACHABLE FASTENER

(71) Applicant: Joseph Christopher Carson, Parsonk, KS (US)

(72) Inventor: Joseph Christopher Carson, Parsonk, KS (US)

(21) Appl. No.: 13/585,484

(22) Filed: Aug. 14, 2012

(51) Int. Cl. A61G 19/00

(52) U.S. Cl. 27/34

(57) ABSTRACT

A casket-lowering strap for lowering a casket into an outer burial container (OBC) includes a pair of clips at respective ends of the strap that are configured to be releasably attached to side rails of a casket-lowering device. The strap includes a first strap section and a second strap section. The first strap section includes a first attachment portion, and the second strap section includes a second attachment portion. The first and second attachment portions are configured to be releasably attached to one another.

### BACKGROUND

I. Field

This application relates generally to straps for lowering a casket into an outer burial container (OBC). More specifically, the application relates to a casketing-lowering strap with a detachable fastener.

II. Background

Straps are utilized to lower a casket into an OBC. Respective ends of the straps are wrapped around a pair of support tubes arranged with respect to the OBC so that the straps span the opening of the OBC. The casket is placed on the straps. The support tubes are then gradually rotated to unroll the straps from the support tubes, thereby gradually lowering the casket.

Rigid metal fasteners are utilized to secure the ends of the straps to the support tubes. The fasteners are typically curved to closely follow the contour of the support tubes. The fasteners are permanently attached to the straps via rivet and are configured to be removed from the support tubes after the straps are completely unwrapped from the support tubes, which occurs after the casket is completely lowered into the OBC.

After lowering the casket, the fasteners are removed from the support tubes. The straps are then pulled out from underneath the casket by pulling up on one end of the strap.

However, there is limited clearance between the casket and the OBC. In some instances, when pulling on one end of the strap, the fastener on the opposite end can jam in a narrow section between the casket and the OBC or some other catch point. In some instances, back and forth rocking of the casket may be required to release the fastener, which can be a dangerous maneuver.

### BRIEF DESCRIPTION

In a first aspect, a casket-lowering strap for lowering a casket into an outer burial container (OBC) includes a pair of clips at respective ends of the strap that are configured to be releasably attached to side rails of a casket-lowering device. The strap includes a first strap section and a second strap section. The first strap section includes a first attachment portion, and the second strap section includes a second attachment portion. The first and second attachment portions are configured to be releasably attached to one another

In a second aspect, a casket-lowering device for lowering a casket into an OBC includes first and second tubular side rails separated by a distance greater than a width of the casket, and first and second straps. Each strap includes a clip at a respective end of the strap that is configured to be releasably attached to one of the first and the second tubular side rails. Each of the first and the second straps comprises a first strap, section that includes a first attachment portion, and a second strap section that includes a second attachment portion. The respective attachment portions are configured to be releasably attached to one another.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 is an exemplary side-view representation of a casket-lowering device (CLD) that includes straps for lowering a casket into an OBC; and

FIG. 2 illustrates an exemplary attachment portion of a strap.

### DETAILED DESCRIPTION

Described below is a strap embodiment that overcomes the problems discussed above. The strap embodiment includes first and second strap sections that are releasably attached to one another. Each strap section includes an attachment portion that includes a fastening material, which facilitates attachment of the first and second strap sections. The fastening material is thinner and more flexible than the clips at the ends of the straps that secure the straps to the side rails. Thus, when the first and second strap sections are separated, the strap more easily slides out from below a casket.

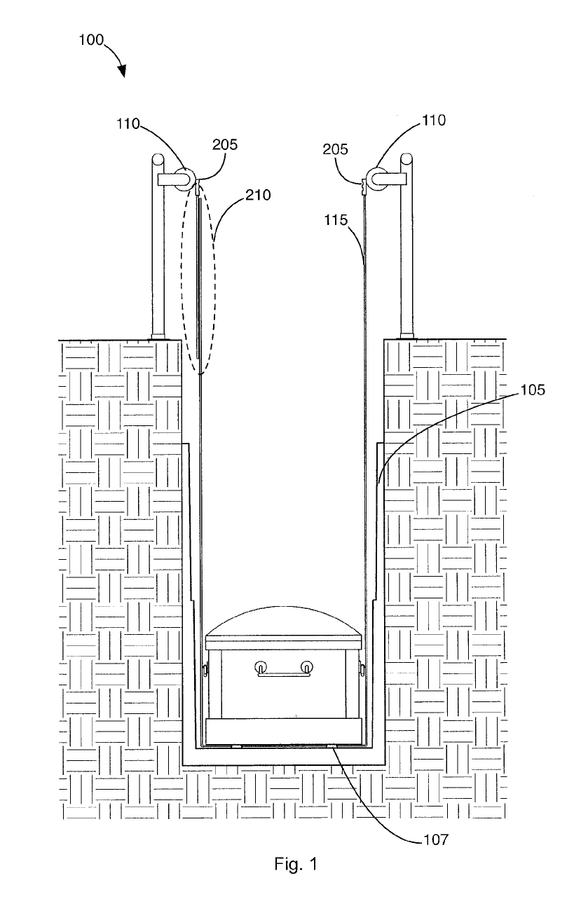

FIG. 1 is an exemplary side-view representation of a casket-lowering device (CLD) 100. The CLD 100 includes a pair of side rails 110 that are separated from one another, a first of which is illustrated. The respective side rails 110 are sized to exceed the length of the casket. The side rails 110 may have a cylindrical shape and may be coupled to a gear mechanism and/or motor that facilitates controlled rotation of the side rails 110 about their respective axis.

Two straps 115 extend between the side rails 110. Ends of the straps 115 are wrapped around the side rails 110. During operation, the straps 115 are wrapped a number of times so that the straps 115 are stretched between the side rails 110. A casket is positioned on the stretched straps 115. To lower the casket, the gear mechanism turns the side rails 110 to unwrap the straps 115 and thereby lower the casket into the OBC 105 until the casket reaches the bottom of the OBC 105. When fully lowered, an attachment section 210 of each strap 115 may be completely unrolled from a side rail 110 to facilitate separating the strap 115 into two sections, as described in more detail below. Spacers 107 positioned below the casket then facilitate pulling of the strap out from underneath the casket.

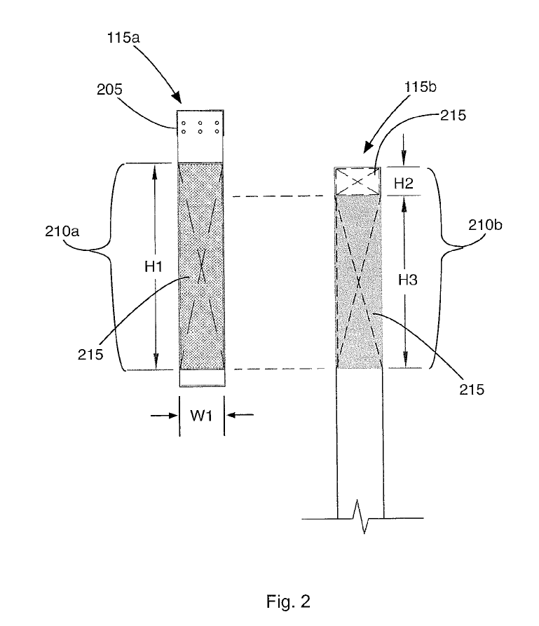

Referring to FIG. 2, each strap 115 includes a clip 205 at either end that is configured to be releasably attached to a respective side rail 110. Each strap 115 also includes a first strap section 115a and a second strap section 115b. The first strap section 115a and the second strap section 115b include first and second attachment portions (210a, 210b), respectively, that are configured to facilitate releasable attachment of the first strap section 115a to the second strap section 115b. In this regard, each attachment portion includes a fastening material 215, such as Velcro®. The amount by which the attachment portions (210a, 210b) overlap is sized to prevent the attachment portions from separating when under the load of an occupied casket.

Table 1 illustrates various alternative dimensions of attachment portions that are capable of withstanding the load exhibited by an occupied casket.

TABLE 1

| | Tensile force | Required | | |
|---|---|---|---|---|
| Product Type | (lbs) | Area (in²) | Width (in) | Height (in) |
| Velcro ® | 354 | 35.4 | 3 | 13 |
| HTH888 | | | | |
| Velcro ® | 354 | 35.4 | 4 | 10 |
| HTH888 | | | | |
| Velcro ® | 354 | 27.2 | 3 | 11 |
| HTH889 | | | | |
| Velcro ® | 354 | 27.2 | 4 | 8 |
| HTH889 | | | | |
| Velcro ® | 225 | 56.25 | 4 | 15 |
| HTH088-0199 | | | | |

In some implementations, the second attachment portion 210b may include user peelable region 215 that does not attach to the first attachment portion 210a. For example, the fastening material 210b may be offset from an end of the second strap section 115b by a distance, H2, or about 2.5 inches resulting in a region of material that, can be pulled upon by the user to facilitate separation of the first and second attachment portions (210a, 210b) by a peeling action. In alternative implementations, rather than offsetting the fastening material 210b, a pullable flap of material may be stitched to the end of the second strap section 115b.

The length, H1, of the fastening material 215 on the first attachment portion 210a may be larger than the length, H3, of the fastening material 215 on the second attachment portion 210b to guarantee a minimum amount of overlap between the respective attachment portions (210a, 210b). For example, if the minimum overlap between the first and second attachment portions (210a, 210b) is determined to be 28 inches, the length, H3, of the fastening material 215 of the second attachment portion may be 28 inches, while the length, H1, of the fastening material 215 of the first attachment portion 210b may be longer, which allows for some margin. In other implementations, the length of the respective attachment portions may be the same. The respective widths, W1, of the attachment portions (210a, 210b) may be about the same and may match the width of the rest of the strap. For example, in one implementation the W1 may be about 3¾ inches.

It is understood that the respective attachment portions (210a, 210b) can be configured in the opposite configuration. For example, the fastening material 215 on the second attachment portion 210b could be the larger of the two. The first attachment portion 210a or both attachment portions (210a, 210b) may include a peelable region 215.

In some implementations, the length of the strap 115 is sized so that the first and second attachment portions (210a, 210b) are unwrapped from the side rails 110 once the casket reaches the bottom of the OBC 105 to facilitate quick removal of the strap 115. Though, it is understood that the strap 115 could also be sized so that part or all of the first and second attachment portions (210a, 210b) remain wrapped around the side rails 110 when the casket is fully lowered into the OBC 105, and that the side rails 110 could be turned further after the casket is completely lowered to unwrap the first and second attachment portions (210a, 210b).

While various embodiments have been described, it will be apparent to those of ordinary skill in the art that many more embodiments and implementations are possible that are within the scope of the claims. For example, while various elements are described as being coupled or connected to one another, the term does not necessarily imply direct coupling or connection in that various intermediary elements may be added between the elements of the embodiments without significantly changing the behavior of the elements. Any such modifications are understood to fall within the scope of protection afforded by the claims. Accordingly, it will be apparent to those of ordinary skill in the art that many more embodiments and implementations are possible that are within the scope of the claims. Therefore, the embodiments described are only provided to aid in understanding the claims and do not limit the scope of the claims.

What is claimed is:

1. A casket-lowering strap for lowering a casket into an outer burial container (OBC) comprising:
a pair of clips at respective ends of the strap that are configured to be releasably attached to side rails of a casket-lowering device;
a first strap section that includes a first attachment portion;
a second strap section that includes a second attachment portion configured to be releasably attached to the first attachment portion.

2. The casket-lowering strap according to claim 1, wherein a length of the first attachment portion and the second attachment portion is about 28 inches.

3. The casket-lowering strap according to claim 2, wherein the second attachment portion includes a user peelable region that does not attach to the first attachment portion to facilitate separation of the second attachment portion from the first attachment portion, wherein the region is positioned at an end of the second strap section.

4. The casket-lowering strap according to claim 3, wherein a length of the user peelable region is about 2.5 inches.

5. The casket-lowering strap according to claim 1, wherein the first and second attachment portions respectively comprise one of a hook portion and a loop portion of a Velcro® fastening material.

6. The casket-lowering strap according to claim 1, wherein a width of the first and second attachment portions matches a width of the strap.

7. The casket-lowering strap according to claim 1, wherein a length of the strap is sized such that the first and second attachment portions are substantially unwrapped from the side rail of the casket-lowering device when the casket is completely lowered within the OBC.

8. A casket-lowering device for lowering a casket into an outer burial container (OBC) comprising:
first and second tubular side rails separated by a distance greater than a width of the casket; and
first and second straps, each strap includes a clip at a respective end of the strap that is configured to be releasably attached to one of the first and the second tubular side rails;
wherein each of the first and the second straps comprises a first strap section that includes a first attachment portion and a second strap section that includes a second attachment portion, the respective attachment portions are configured to be releasably attached to one another.

9. The casket-lowering device according to claim 8, wherein a length of the first attachment portion and the second attachment portion is about 28 inches.

10. The casket-lowering device according to claim 9, wherein the second attachment portion includes user peelable region that does not attach to the first attachment portion to facilitate separation of the second attachment portion from the first attachment portion, wherein the region is positioned at an end of the second strap.

11. The casket-lowering device according to claim 10, wherein a length of the user peelable region is about 2.5 inches.

12. The casket-lowering device according to claim 8, wherein the first and second attachment portions respectively comprise one of a hook portion and a loop portion of a Velcro® fastener.

13. The casket-lowering device according to claim 8, wherein a width of the first and second attachment matches a width of the strap.

14. The casket-lowering device according to claim 8, wherein a length of each strap is sized such that the first and second attachment portions are substantially unwrapped from a respective side rail of the casket lowering device when the casket reaches a bottom of the OBC.
